(19) United States
(12) Patent Application Publication
(10) Pub. No.: US 2024/0091706 A1
(43) Pub. Date: Mar. 21, 2024

(54) OSMOTIC PROCESSES

(71) Applicant: SALTPOWER HOLDING APS, Sønderborg (DK)

(72) Inventors: Henrik Tækker Madsen, Copenhagen (DK); Lars Storm Pedersen, Egernsund (DK)

(73) Assignee: SALTPOWER HOLDING APS, Sønderborg (DK)

(21) Appl. No.: 18/266,641

(22) PCT Filed: Dec. 14, 2021
(86) PCT No.: PCT/EP2021/085685

§ 371 Date: Jun. 12, 2023

(30) Foreign Application Priority Data
Dec. 14, 2020 (GB) 2019662.2

(51) Int. Cl. B01D 61/00; C02F 1/42; C02F 1/44; C02F 1/469

(52) U.S. Cl. CPC B01D 61/0022; C02F 1/42; C02F 1/442; C02F 1/445; C02F 1/4693

(57) ABSTRACT

An osmotic process is disclosed. The process comprises passing a draw stream (12) and a feed stream (2), the feed stream (2) being an aqueous stream of lower salinity than said draw stream (12), through an osmotic unit (8) in which water but not salts pass from the feed stream (2) to the draw stream (12). The process further comprises passing the feed stream through an ion exchange unit (4a, 4b) in which an ion exchange process is used to treat the feed stream (2) before the feed stream (2) passes through the osmotic unit (8) and using the draw stream (12) in said ion exchange process before or after the draw stream (12) passes through the osmotic unit (8). A power generation process and an electricity generation process based on the osmotic process is also described, along with a system for carrying out the osmotic process.

### FIELD OF THE INVENTION

The present invention concerns treatment of fluid streams used in osmotic processes that rely on a concentration gradient to drive the process and, in particular, osmotic power generation processes. More particularly, but not exclusively, this invention concerns an osmotic processes, an osmotic power generation process and a system for carrying out such processes.

### BACKGROUND OF THE INVENTION

Osmotic processes (also known as salinity gradient processes) include pressure retarded osmosis (PRO), forward osmosis (FO) and reverse electrodialysis (RED). Such processes operate with two streams, a relatively low salinity feed stream and a relatively high salinity draw stream and rely on the concentration gradient to drive the process. Thus, such processes involve movement of molecules and/or ions from the low salinity stream to the high salinity stream i.e. with the concentration gradient. The feed stream and draw stream may be separated by a semipermeable membrane and the osmotic process relies on the movement of molecules and ions across along the concentration gradient across the membrane. For PRO and FO the solvent such as water will move through the membrane from the feed stream to the draw stream due to the osmotic gradient between the two streams. In RED, it is the ions that flow along the salinity gradient through an alternating stack of cationic and anionic exchange membranes.

In such osmotic processes, pretreatment is important to achieve a stable process, avoid contamination of the output stream(s) and/or to avoid scaling of the membrane. This is particularly the case with FO and PRO processes because the feed stream is concentrated during these processes, which may bring dissolved species to a supersaturated concentration leading to precipitation and scaling of the membrane. Scaling of the membrane incurs a cost either due to cleaning or complete replacement of the membrane and/or reduces the efficiency of the osmotic process. Scaling may also set a limit to the recovery of the feed stream, which affects the process economy.

A variety of pretreatment methods can be used to avoid membrane scaling and increase feed recovery in osmotic processes. Scaling due to hardness ions (calcium and magnesium carbonates) can be reduced by pH adjustment with acid, and antiscalant formulations that increase solubility and/or delay precipitation kinetics can also be used, for instance to remove iron and manganese. Alternatively, membrane processes such as nanofiltration and low pressure reverse osmosis can be used. These will lower concentrations of all ions, but are themselves susceptible to scaling and they require energy, which lowers net energy output of the power generation process and increases the overall capital expenditure.

For the avoidance of doubt, reverse osmosis is not an osmotic process as that term is used herein because reverse osmosis relies on a hydrostatic pressure difference to move solvent against the concentration gradient whereas osmotic processes rely on the difference in concentration to drive the process.

It would be advantageous to provide more compact and/or energy efficient pretreatment for osmotic processes.

An alternative to these pretreatment processes is ion exchange. In ion exchange a charged resin saturated with moveable ions, for example such as sodium and chloride, exchanges these ions with ions in the stream sent to the ion exchange system for treatment. Ions with multivalent charge, for example such as Ca′ and Mg′, will have a high affinity for the ion exchange resin and will be almost completely adsorbed thereby reducing contamination in the stream. Once the capacity of the resin has been met (i.e. the supply of moveable ions has been depleted), the resin must be regenerated by passing a concentrated solution over the resin. For example, by passing a concentrated sodium chloride solution over the resin, to exchange the adsorbed ions back with moveable ions (e.g. sodium and chloride). After regeneration, the ion exchange system is rinsed to expulse the residual salinity and can then be brought back in operation. One of the main issues for ion exchange is the consumption of salt for regeneration, which adds costs to the system.

The operation of the ion exchange process is generally improved with increasing concentration of the solution used for regeneration as a more concentrated solution allows a more complete desorption of the bound ions during regeneration. This can be seen from a consideration of the separation factor, here with Ca and Na as examples. However, the cost of generating large volumes of high concentration solutions can be prohibitive.

For a 26% saturated solution the affinity for calcium over sodium is weak with a separation factor less than one, whereas for a typical raw water with a Total Dissolved Solids (TDS) of 500 mg/L the separation factor is more than 28. It follows that very high desorption of calcium can be achieved with saturated brine. However, the industry standard is to use a 10% wt (brine) solution for regeneration. The separation factor for a 10% wt (brine) solution is 1.54, and because the additional gain for higher salinities is relatively small a cost benefit analyses finds 10% to be an optimum value—which has been widely adopted in industry.

The present invention seeks to mitigate the above-mentioned problems. Alternatively or additionally, the present invention seeks to provide an improved osmotic process.

### SUMMARY OF THE INVENTION

The present invention provides, according to a first aspect, an osmotic process. The process may comprise passing a draw stream and a feed stream, said feed stream being an aqueous stream of lower salinity than said draw stream, through an osmotic unit in which water but not salts pass from the feed stream to the draw stream. The process may comprise passing the feed stream through an ion exchange unit to treat the feed stream, for example before the feed stream passes through the osmotic unit. The process may comprise using the draw stream as part of said ion exchange process before or after the draw stream passes through the osmotic unit. The process may comprise passing the draw stream through the ion exchange unit before or after the draw stream passes through the osmotic unit. It may be that (i) the ion exchange unit comprises a first portion of ion exchange resin and the process comprises passing the feed stream over said first portion of ion exchange resin at a first time and passing the draw stream over said first portion of ion exchange resin at a second, different time; and/or (ii) the ion exchange unit comprises an ion exchange membrane and the process comprises passing the feed stream over one side of the ion exchange membrane (e.g. at a first time), the draw stream being passed over the other side of said ion exchange membrane (at the same time, e.g. at the first time). Thus, the draw stream said may be used in the ion exchange process at the same time as the feed stream is treated or before and/or after the feed stream is treated.

Thus, the present invention may make use of the (higher-salinity) draw stream of an osmotic process in an ion-exchange process that is used to treat the (lower-salinity) feed stream of the osmotic process. Use of the draw solution in the ion-exchange process may reduce or remove the need for an external supply of salt (and the associated financial and energy costs for production and/or transport of said salt). Additionally or alternatively (and without wishing to be bound by theory) the energy required to remove the unwanted contaminants from the feed stream is contained within the osmotic or “entropic” potential between the feed stream and the draw stream, thereby reducing the energy required for treatment.

‘Treating’ or ‘pretreating’ a stream may refer to the removal of unwanted contaminants from said stream. It may be that said (pre) treatment reduces the level of said contaminants by at least 40% wt, for example at least 60% wt, for example by more than 80% wt.

In prior art ion exchange processes it is desirable to limit the volume of and/or concentration of the saline solution used to regenerate an ion exchange resin because there is a cost associated with its production, and that cost typically increases with concentration. That cost is removed in processes in accordance with the present invention, because the saline solution (the draw solution) is already required for the osmotic process. This removal of this commercial constraint may lead to an improved ion exchange process.

Higher salt concentrations may allow for improved performance of the ion exchange resin as a result of improved (for example more complete) desorption of the bound ions during regeneration, but higher salt concentrations are more expensive. The draw stream for an osmotic process may already have a salt content well in excess of 10% wt (the industry standard salt content for brines used in the regeneration of ion exchange resins) and because the draw stream is already provided for the osmotic process this improved performance ion regeneration can be achieved in the process of the present disclosure without significant extra (money, time or energy) cost. The situation is similar where an ion exchange membrane is used in place of an ion exchange resin, with use of a highly saline draw stream in the ion exchange membrane leading to improved pre-treatment. Good pre-treatment may allow for higher recovery of the feed solution, which reduces the required feed pressure and thereby increases the net energy production and/or reduce the risk of scaling thereby improving the lifetime of the membranes.

For draw streams having lower salt contents the processes of the present invention may still offer an improvement. While the desorption is not as effective with lower concentration draw streams, because there is no longer the same need to limit the volume of saltwater used the desorption can be allowed to run for a longer period of time.

An added benefit of achieving more complete desorption for regeneration of ion-exchange resins, is that leakages of adsorbed ions, such as hardness leakage, may be reduced. After a regeneration, a small amount of adsorbed ions may still be present on the resin. When new feed water is introduced to the ion exchange unit, it will interact with the first part of the resin material and the contaminant ions will be substantially completely removed and replaced with sodium. The feed water travels through the ion exchange unit it meets the resin with still small amounts of adsorbed ions. The feed water and the resin are now out of equilibrium and a part of the adsorbed ions will desorb into the feed stream creating a leakage of ions that will be present in the treated feed stream. Additionally or alternatively, using high concentrations for regeneration leads to more efficient desorption of strongly bound ions such as iron and aluminum.

It may be that the draw stream is passed through the ion exchange unit and the osmotic unit. The draw stream may pass through the ion exchange unit (and over the ion exchange resin or membrane) before or after passing through the osmotic unit. Use of the same solution in both the ion exchange unit and the osmotic unit reduces the amount of draw fluid required overall. Further, the salinity of the draw fluid used in the ion exchange unit is reduced by passed through the osmotic unit thereby facilitating disposal of the fluid in comparison to ion exchange processes that do not involve an osmotic unit (lower salinity fluid having lesser environmental impact and/or requiring less treatment before it can be safely discharged). However, at some time in the process it may be desirable that a first part of the draw stream is passed through the osmotic unit (but not the ion exchange unit) and a second, different, part of the draw stream is passed through the ion exchange unit (but not the osmotic unit). In this case, the second part of the draw stream may bypass the osmotic unit.

It may be that the draw stream passes directly between the ion exchange unit and the osmotic unit. For example, it may be that the draw stream does not undergo any treatment step when passing between the ion exchange unit and the osmotic unit. It may be that the salinity of the draw stream remains substantially unchanged between the outlet from one of the ion exchange unit and the osmotic unit and the inlet of the other of the ion exchange unit and the osmotic unit.

It may be that the draw stream passes through the ion exchange unit and then passes through the osmotic unit. For example, the osmotic unit may be located immediately downstream of the ion exchange unit. It may be that the salinity of the draw stream leaving the ion exchange unit is substantially identical to the salinity of the draw stream received at the osmotic unit.

It may be that the draw stream passes through the osmotic unit and then passes through the ion exchange unit. For example, the ion exchange unit may be located immediately downstream of the osmotic unit. It may be that the salinity of the draw stream leaving the osmotic unit is substantially identical to the salinity of the draw stream received at the ion exchange unit.

The osmotic unit may comprise a semipermeable membrane which permits the passage of water but not the passage of salts. The process may comprise passing said draw stream through the osmotic unit in which the draw stream is passed over one side of a semi-permeable membrane and the feed stream is passed over the other side of said membrane so water passes across the membrane from the feed stream to the draw stream.

The improved treatment provided by the process of the present invention may be of particular benefit in reducing scaling of the semipermeable membrane, by providing improved removal of contaminant scalants from the feed stream.

Ion exchange processes as described herein may remove most types of in-organic ions that contaminate feed streams, but it may be that ion exchange processes as described herein do not remove silica. The presence of silica in the feed stream may result in scaling of the membrane in the osmotic unit. However, (without wishing to be bound by theory) ion exchanges process in accordance with the present invention may replace calcium and aluminium ions in the feed stream (which may encourage silica precipitation) with sodium ions (which may inhibit silica precipitation). Thus, in addition to reducing costs of pre-treatment, processes in accordance with the present invention may provide improved osmotic processes by reducing scaling of the semipermeable membrane, even where the scalant is not removed by the ion exchange treatment.

The process may be an osmotic power generation process. The process may comprise converting latent osmotic energy present in a draw stream into power by passing the draw stream and the feed stream through an osmotic unit. It may be that the osmotic unit is an osmotic power unit.

Osmotic power generation processes are powered by osmosis, and convert latent osmotic energy into useful power, for example mechanical or hydraulic work and/or electricity. An osmotic power unit is a unit which converts latent osmotic energy into power. Any suitable osmotic power unit may be used in the process of the present invention. An osmotic power unit may comprise a semi-permeable membrane which permits the passage of water but not of dissolved salt(s), for example where the osmotic power unit is arranged to generate power through PRO, or a semi-permeable membrane which permits the passage of ions with a positive or negative charge, but not ions having a different charge, for example where the osmotic power unit is arranged to generate electricity through RED. Such membranes are commercially available, and any suitable membrane may be used. More than one semi-permeable membrane may be present, and combinations of different types of membranes may be used. An osmotic power unit (for example where PRO is used) may comprise means for converting pressure or flow generated by osmosis (for example osmosis across the semi-permeable membrane) into mechanical work or electricity. For example, an osmotic power unit may comprise a turbine and/or a generator. It may be that the turbine is connected to the generator to produce electricity.

Where a semi-permeable membrane that permits the passage of water but not salts is used, the inputs to the osmotic unit comprise one higher salinity stream (the draw stream), and one lower salinity stream (the feed stream). After passage over the membrane, the first stream (initial higher salinity) will be reduced in salinity, while the second stream (initial lower salinity) will be increased in salinity. The output streams from a first pass over the membrane will both have lower salinity than the original saline stream, and higher salinity than the original lower salinity stream—at equilibrium, the two streams would have equal salinity, but this is unlikely to be achieved in practice. Therefore, either output stream can be reused as either the first stream or the second stream for a second pass over the original membrane, or as either the first stream or the second stream over a second membrane. These reused streams may be used alone, or merged with other input streams. Each step may have a different pressure and/or flux setting depending on the difference in salinity between the initial input streams for each pass. Tailoring the pressure and/or flux setting in this manner may increase the efficiency of the process. As long as an outgoing stream from a membrane has higher salinity than the initial input stream of lower salinity, it is possible to operate an additional membrane. The optimal number of cycles will depend on the initial content of the streams, the efficiency of the membranes, and the flow rates selected. The outputs from the osmotic unit comprise a concentrated feed stream (e.g. the feed stream less the water that has passed into the draw stream) and a dilute draw stream (e.g. the draw stream plus the water from the feed stream).

The ion exchange unit comprises an ion exchange resin (e.g. a resin that acts as a medium for ion exchange) or an ion exchange membrane (e.g. a semi-permeable membrane that transports dissolved ions having a particular charge while blocking other ions and/or neutral molecules). If more than one ion exchange unit is involved in the process, each ion exchange unit comprises an ion exchange resin or an ion exchange membrane. Ion exchange resins and membranes are commercially available and any appropriate resin or membrane may be used.

The ion exchange resin may be a cationic ion exchange resin or an anionic ion exchange resin. The ion exchange resin may be configured to exchange contaminant ions (for example nitrate, magnesium, calcium, ammonium, aluminum, iron, barium, manganese, strontium, carbonate and/or sulphate ad phosphate ions) in the feed stream for exchange ions (for example sodium or chloride ions as appropriate in view of the charge of the ion in question) in the resin. The ion exchange resin may be configured to exchange said exchange ions present in the draw stream for said contaminant ions in the resin such that the resin is regenerated.

The ion exchange process may comprise a treatment step in which ions (e.g. contaminant ions) from the feed stream are exchanged with other ions (e.g. exchange ions). In the case that an ion exchange membrane is used the draw stream is used during the treatment step. Thus, ions from the feed stream are exchanged with ions from the draw stream. In the case that a resin is used, ions from the feed stream are exchanged with ions from the ion exchange resin during the treatment step. In the case that an ion exchange resin is used, the ion exchange process may comprise a regeneration step in which ions lost from the resin are replenished using the draw stream. For example, ions from the draw stream may be exchanged with ions from the resin during the regeneration step.

The ion exchange resin may be a cationic exchange resin capable of binding monovalent, divalent and/or higher valency cations present in the feed stream, for example magnesium, calcium, ammonium, aluminum, barium, manganese, strontium and/or iron ions. The ion exchange resin may be a cationic exchange resin capable of binding cations, for example monovalent cations (e.g. sodium or potassium ions) present in the draw stream. For example, the ion exchange resin may be configured to exchange magnesium, calcium, ammonium, aluminum, barium, manganese, strontium and/or iron ions in the feed stream with sodium or potassium ions and to be regenerated by exchanging magnesium, calcium, ammonium, aluminum and/or iron with sodium ions from the draw stream.

The ion exchange resin may be an anionic exchange resin capable of binding monovalent, divalent and/or higher valency anions (for example nitrate, carbonate and/or sulfate ad phosphate) present in the feed stream. The ion exchange resin may be a anionic exchange resin capable of binding anions, for example monovalent ions (e.g. chlorine ions). For example, the ion exchange resin may be configured to exchange nitrate, carbonate and/or sulfate ad phosphate ions in the feed stream with chloride ions and to be regenerated by exchanging nitrate, carbonate and/or sulfate ad phosphate ions with chloride ions from the draw stream.

Ions of higher valency will tend to have larger size compared to monovalent ions such as chloride and thus a lower diffusion coefficient. Without wishing to be bound by theory, this means they may reach higher concentrations in the support layer of the osmotic membrane (known as internal concentration polarization) where concentration is determined by the flux of water from the feed stream through the membrane, the membrane/ion rejection rate and the ion back diffusion rate. By exchanging ions with lower diffusion coefficient to ions with higher diffusion coefficients, a lower internal concentration polarization may be achieved. Use of a resin configured to bind nitrate may allow for selective removal of nitrogen and/or phosphorous nutrients from the feed stream.

It may be that more than one type of ion exchange resin is used in the process. For example, a mixture of cationic and anionic exchange resins, or combinations of cationic and/or anionic exchange resins capable of binding different ions. Different types of resin can be used in a mixed bed in the same vessel and/or in separate vessels Thus, more than one type of ion exchange resin may be provided in the same ion exchange unit, or in different ion exchange units.

In the case that the ion exchange unit comprises an ion exchange resin, the process comprises passing the draw stream over the ion exchange resin to regenerate the ion exchange resin. It may be that the feed stream is passed over a first portion of ion exchange resin to treat the feed stream while the draw stream is passed over a second, different, portion of ion exchange resin to regenerate said second portion of ion exchange resin, for example during a first time period. Then, the feed stream may be passed over the second portion of ion exchange resin while the draw stream is passed over the first portion of ion exchange resin, for example for a second, later, time period. It may be that the draw stream and feed stream are passed through the osmotic power unit while the feed stream and draw stream are passed over the first and/or second portions of ion exchange resin. A portion of ion exchange resin may be said to be ‘online’ while the feed stream is passed through said resin to treat the feed stream. A portion of ion exchange resin may be said to be ‘offline’ while the feed stream is not passed through the ion exchange resin. It may be that while the ion exchange resin is offline the draw stream is passed through said unit to regenerate the ion exchange resin. Thus, it may be that while the feed and draw streams are being passed through the osmotic unit, at least one portion of ion exchange resin is online and at least one portion of ion exchange resin is offline. The process may comprise switching each portion of ion exchange resin between the online and offline states by changing the flow path of the feed and/or draw streams. For example, it may be that during a first time period the first portion of resin is online and the second portion of resin is offline, during a second, later, time period the first portion of resin is offline and the second portion of resin is online, during a third, yet later, time period the first portion of resin is online and the second portion of resin is offline, and/or during a fourth, yet later, time period the first portion of resin is offline and the second portion of resin is online. This pattern may continue while the osmotic power unit is in operation. The switching may be carried out periodically (e.g. after a set period of time has elapsed) or once the efficacy of a portion of ion exchange resin falls below a predetermined threshold.

It may be that the or each portion of ion exchange resin is switched to an offline state while at least 20%, for example at least 30%, for example at least 40%, for example at least 50% of the resin capacity remains. Methods for calculating the resin capacity that remains will be well known to the skilled person. This may be cost effective in the present process because the draw solution is continuously available while the osmotic power unit is in operation. Switching while a significant proportion of the resin capacity remains may result in an improved osmotic process because the feed water can be treated with high efficiency as the ion exchange resin is always close to full capacity, leakages are reduced because the ion exchange resin near the exit can be left inactive and/or when shorter online intervals are used a lesser amount of solids accumulates on the ion exchange resin.

The process may comprising flushing a portion of ion exchange resin after the draw stream has been passed over said portion, for example after regeneration and/or before it is brought online, for example at the end of the first and/or second time period. Flushing may be carried out to remove any remaining draw solution (e.g. fluid from the draw stream) from said portion of resin. Flushing may comprise passing a flushing stream (having lower salinity than the draw stream, for example being the feed stream or another low salinity stream) through the ion exchange resin to displace any remaining fluid from the draw stream. Draw solution displaced in this way may be referred to as displaced draw fluid. Such fluid may be disposed of as appropriate.

It may be that the discharge stream is mixed with the dilute draw stream from the osmotic power unit, and (optionally) disposed of as appropriate.

Each ion exchange unit may comprise one or more vessels, for example one or more columns, capable of holding ion exchange resin. The feed stream may flow upwards through each vessel and over the resin, for example from one or more inlets to one or more outlets located above said inlet(s). The feed stream may flow downwards through each vessel and over the resin, for example from one or more inlets to one or more outlets located below said inlet(s). During regeneration, the draw stream may flow upwards through each vessel and over the resin, for example from one or more inlets to one or more outlets located above said inlet(s). During regeneration, the draw stream may flow downwards through each vessel and over the resin, for example from one or more inlets to one or more outlets located below said inlet(s). An ion exchange unit may comprise one or more types of ion exchange resin. For example, an ion exchange unit may comprise both anionic and cationic ion exchanged resin in different vessels or in a mixed bed. Alternatively, ion exchange resins of different types may form part of different ion exchange units. An ion exchange unit may comprise the first and second portions of ion exchange resin. Alternatively, a first ion exchange unit may comprise the first portion of ion exchange resin while a second ion exchange unit comprises the second portion of ion exchange resin.

The salt content of the draw stream may be anything up to saturation. Preferably the salt content is at least 10% wt, preferably at least 15% wt, preferably at least 20% wt, especially at least 25% wt. It will be understood that the draw stream may contain a wide variety of dissolved salts, with a preponderance of sodium chloride, and that “salt content” refers to total salt content. The exact nature of the salt(s) present in such streams is not important (provided the salts provide ions appropriate for use in the regeneration of the ion exchange resin, if used). Similarly, the terms high(er)-salinity and low(er)-salinity are used herein to refer to streams having a corresponding “salt content”—the exact nature of the salt(s) present in such streams is not important.

The process may comprise extracting the draw stream from an underground formation, for example a geothermal formation and/or salt formation. Alternatively, the draw stream may be seawater. Alternatively, the draw stream may be desalination brine (also known as concentrate or reject) from a desalination unit, for example the concentrated saline stream produced by a reverse osmosis process.

The process may comprise extracting the draw stream from the salt formation using a solution mining process. For example by injecting an unsaturated stream into the salt formation to dissolve the salt contained therein, and then extracting a stream containing said dissolved salt from the salt formation. The stream so extracted may be used as the draw stream. The diluted draw stream, the concentrated feed stream, the discharge stream, the displaced draw fluid and/or the flushing stream may be used as and/or form part of the unsaturated stream in such a solution mining process. Use of non-saturated streams produced by the osmotic process in the solution mining process may reduce the amount of fresh water required, and/or provide a draw stream comprising lower levels of impurities than draw streams from other sources.

The feed stream may be ground water, sea water, or surface water, for example fresh or brackish water obtained, for example, from a river or a lake. The feed stream may be waste water obtained from an industrial source (for example condensate) or municipal source (for example sewage).

The dilute draw stream (or a portion thereof) from the osmotic unit may be returned to the source of the draw stream, which may be referred to as the draw stream reservoir. For example, at least part of the dilute draw stream may be returned to the geothermal formation and/or salt formation from which the draw stream is extracted.

The process may comprise passing at least part of the dilute draw stream, for example a portion of the dilute draw stream substantially equal to the permeate flow across the membrane, from the osmotic unit through an ion exchange unit comprising a portion of ion exchange resin and/or an ion exchange membrane to treat the dilute draw stream. The process may comprise passing the (undiluted) draw stream through the ion exchange unit to regenerate the ion exchange resin and/or on the other side of the ion exchange membrane to the dilute draw stream. As described above in connection with the purification of the feed stream, first and second portions of ion exchange resin may be used to treat the dilute draw stream, for example with one portion being online while the other is offline. Aspects of the ion exchange unit, ion exchange resin, ion exchange membrane or process described above in connection with purification of the feed stream may apply equally for purification of the diluted draw stream, unless such aspects are clearly incompatible. Using the draw stream in the purification of the dilute draw stream may further increase the efficiency of the process while facilitating disposal of the dilute draw stream. Purification of the dilute draw solution may be advantageous where it is desirable to conserve the total volume of solution in the draw stream reservoir or where circumstances mean it is desirable to return a portion of the dilute draw stream to the environment. Where it is desirable to conserve the total volume of solution in the draw stream reservoir, the surplus volume generated by the osmotic process must be safely discharged to the feed solution reservoir or another suitable recipient. This volume is equal to the permeate flow, dependent on density changes and whether or not it is mixed with other waste or residual streams.

The dilute draw stream may be passed across an ion exchange resin configured to bind ammonium ions present in the dilute draw stream (and to be regenerated with the sodium ions in the dilute draw stream). The dilute draw stream may be passed across an ion exchange membrane configured to transfer ammonium ions present in the dilute draw stream with sodium ions in the (non-dilute) draw stream. Ammonium can be present in significant quantities in reduced brines and can prevent safe discharge of the diluted draw fluid to the environment.

The steps of passing the feed and draw stream through the osmotic unit, passing the feed stream over the first portion of ion exchange resin and passing the draw stream over the second portion of ion exchange resin may be carried out simultaneously. Passing the feed and draw stream through the osmotic unit, passing the feed stream over the second portion of ion exchange resin and passing the draw stream over the first portion of ion exchange resin may be carried out simultaneously. It may be that passing the feed stream over the first portion of ion exchange resin and passing the draw stream over the first portion of ion exchange resin are carried out a different times. It may be that passing the feed stream over the second portion of ion exchange resin and passing the draw stream over the second portion of ion exchange resin are carried out a different times.

In the case that the feed stream is passed over an ion exchange membrane, the feed stream is passed over one side of the ion exchange membrane while the draw stream is passed over the other side of the ion exchange membrane such that ions pass between the draw stream and the feed stream. Thus, for an ion exchange membrane, the draw stream and feed stream are passed over the same membrane simultaneously.

An ion exchange membrane allows ions of the same charge (positive or negative) to transfer trough the membrane while preventing ions without said charge passing the membrane. When passing draw solution on one side of the membrane and feed water on the other side, the Donnan effect would lead to exchange of divalent ions in the feed with monovalent ions in the draw. The monovalent ions in the draw will diffuse along the concentration gradient into the feed solution, but since only ions of the same charge can pass the membrane and in order to maintain charge neutrality, divalent ions must diffuse from the feed into the draw.

The ion exchange membrane may be a cationic exchange membrane. If the draw solution is primarily sodium chloride and the feed contain calcium ions, then two sodium ions will be transferred to the feed for every calcium ion removed.

The ion exchange membrane may be an anionic exchange membrane, for example configured to remove sulphate, carbonate and/or phosphate from the feed stream.

The process may use more than one type of membrane to treat each of the feed stream and/or the draw stream. For example, both cationic and anionic membranes may be used are used to pretreat the feed water.

The osmotic power unit may convert latent osmotic energy present in said high salinity stream into electricity by Reverse ElectroDialysis (RED). In an osmotic power unit configured to produce electricity by RED a stack of ion exchange membranes is located between an anode and a cathode. Each ion exchange membrane is either a cation exchange membrane (permits the passage of cations but not anions) or anion exchange membrane (permits the passage of anions but not cations). Thus each ion exchange membrane is a semi-permeable membrane permitting the passage of ions with a negative charge or ions with a positive charge. The stack comprises a plurality of units, each unit comprising (in order) a high-salinity channel, a cation exchange membrane (CEM), a low salinity channel, and an anion exchange membrane (AEM). In use, cations from the high-salinity channel (e.g. a channel in which a portion of the draw stream flows) pass through the CEM to the low salinity channel (e.g. a channel in which a portion of the feed stream flows) of the same unit, while anions from the high-salinity channel pass through the AEM of the adjacent unit into the low salinity channel of an adjacent unit. This flow of ions can be used to generate an electric current. By way of example, where the salt of the present process comprises sodium chloride, positively charged sodium ions will pass through the CEM from the high salinity stream (a portion of the draw stream) to the low salinity stream (a portion of the feed stream) and negatively charged chlorine ions will pass through the AEM from the high salinity stream (a portion of the draw stream) to the low salinity stream (a portion of the feed stream). Thus, the salinity of the draw stream is reduced by passage through the osmotic power unit to produce an dilute draw stream and a concentrated feed stream. RED may be an efficient and effective process for capturing the osmotic energy present in the draw stream.

It may be that, when using the RED process any discharge stream produced following regeneration of an ion exchange resin, bypasses the osmotic power unit, for example to is sent direct to the draw solution reservoir. This may reduce the amount of divalent ions (which may hamper the RED process) being passed to the osmotic power unit.

In a second aspect of the invention, there is provided an electricity generation process comprising passing at least part of the draw stream, for example a draw stream being a saline stream having a salt content of at least 10% wt, through a reverse electrodialysis unit in which said draw stream is passed over one side of a cation-exchange membrane which permits the passage of cations but not the passage of anions and over one side of an anion-exchange membrane which permits the passage of anions but not cations, and a feed stream, being an aqueous stream of lower salinity than said draw stream, is passed over the other side of said cation-exchange membrane and the other side of said anion-exchange membrane to generate electricity. The process may comprise passing the feed stream through an ion exchange unit in which an ion exchange process is used to treat the feed stream before the feed stream passes through the reverse electrodialysis unit. The process may comprise using the draw stream in said ion exchange process before or after the draw stream passes through the osmotic power unit. It may be that the ion exchange unit comprises a first portion of ion exchange resin and the process comprises passing the feed stream over said first portion of ion exchange resin at a first time and passing the draw stream over said first portion of ion exchange resin at a second, different, time. It may be that the ion exchange unit comprises an ion exchange membrane and the process comprises passing the feed stream over one side of the ion exchange membrane, the draw stream being passed over the other side of said ion exchange membrane

Any aspect of the invention described above with respect to the first aspect of the invention may apply equally to the second aspect of the invention.

In a third aspect of the invention, there is provided a system for carrying out the processes of the first and/or second aspect.

For example, there may be provided a system comprising one or more of a first portion of ion exchange resin; a second portion of ion exchange resin; and an osmotic unit. The osmotic unit may be arranged to carry out an osmotic process using the difference in salinity between a draw stream and a feed stream. The system may be arranged such that in a first configuration the feed stream passes over the first portion of ion exchange resin and the draw stream passes over the second portion of ion exchange resin; and in a second configuration the feed stream passes over the second portion of ion exchange resin and the draw stream passes over the first portion of ion exchange resin. Thus, the system may be operable in the first and second configurations, and configured to switch between the first and second configurations. The system may be configured to switch regularly between the first and second configurations.

The system may comprise one or more valves that control the flow of the draw stream and/or the feed stream through the system such that operating (for example changing the position of, for example opening and/or shutting) said valves switches the system between the first and second configuration.

The system may comprise a control system configured to operate the process, for example to control the switching of the system between the first and second configurations, for example by controlling the one or more valves. The control system may be configured to switch the system periodically (e.g. after a fixed period of time) and/or in response to one or more signals corresponding to a measure of the process (for example the operation and/or capacity of the ion exchange resin and/or the quality of the feed stream after passing through the ion exchange unit).

The osmotic unit may comprise a semi-permeable membrane which permits the passage of water but not of dissolved salts. The system may be arranged so that the draw stream passes over one side of the semi-permeable membrane and the feed stream passes over the other. It may be that the osmotic unit is an osmotic power unit arranged to convert latent osmotic energy present in the draw stream into power, for example to generate electricity through Pressure Retarded Osmosis (PRO) using the difference in salinity between the draw stream and the feed stream. It may be that the osmotic unit is arranged to carry out Forward Osmosis (FO) using the difference in salinity between the draw stream and the feed stream.

It may be that the osmotic unit is an osmotic power unit arranged to generate electricity through Reverse Electrodialysis (RED) using the difference in salinity between the draw stream and the feed stream. The osmotic power unit may comprise a stack of ion exchange membranes located between an anode and a cathode. Each ion exchange membrane is either a cation exchange membrane (permits the passage of cations but not anions) or anion exchange membrane (permits the passage of anions but not cations). The stack comprises a plurality of units, each unit comprising (in order) a high-salinity channel (through which in use a portion of the draw stream flows), a cation exchange membrane (CEM), a low salinity channel (through which is use a portion of the feed stream flows), and an anion exchange membrane (AEM).

The system may comprise one or more pumps and/or a control system. The power generation system may comprise other conventional apparatus for carrying out the osmotic and/or ion exchange process. For example, one or more pumps arranged to circulate the feed, draw, concentrated feed and/or dilute draw streams.

The system may comprise an injection well, via which the dilute draw stream is or can be injected into a mineral formation. The injection well may be suitable for injecting the dilute draw stream into a mineral formation. The system may comprise an extraction well, via which the draw stream is or can be extracted from a mineral formation. The extraction well may be suitable for extracting the draw stream from a mineral formation. The injection well and extraction well may be connected to the same mineral formation.

In the case that the system comprises an osmotic power unit arranged to generate power and/or electricity using the difference in salinity between the draw stream and the feed stream, the system may be referred to as a power generation system.

It will be understood that the process or apparatus of the present invention may be described as a power generation process or system where an osmotic power unit is used because the osmotic power unit produces power (for example useful work, for example electricity or mechanical work). It will be appreciated that the amount of power produced will vary depending on the process parameters.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows an example process according to the invention at a first time;

FIG. 2 shows the process of FIG. 1 at a second, later, time;

FIG. 3 shows the process of FIG. 1 at a different time;

FIG. 4 shows a second example process according to the invention being a variation of the process of FIG. 1;

FIG. 5 shows a third example process according to the invention being a variation of the process of FIG. 1;

FIG. 6 shows a fourth example process according to the invention being a variation of the process of FIG. 1;

FIG. 7 shows a fifth example process according to the invention;

FIG. 8 shows an example osmotic power unit for use in the process and/or an embodiment of the invention

FIG. 9 shows a second example osmotic power unit for use in the process and/or an embodiment of the invention

### DETAILED DESCRIPTION

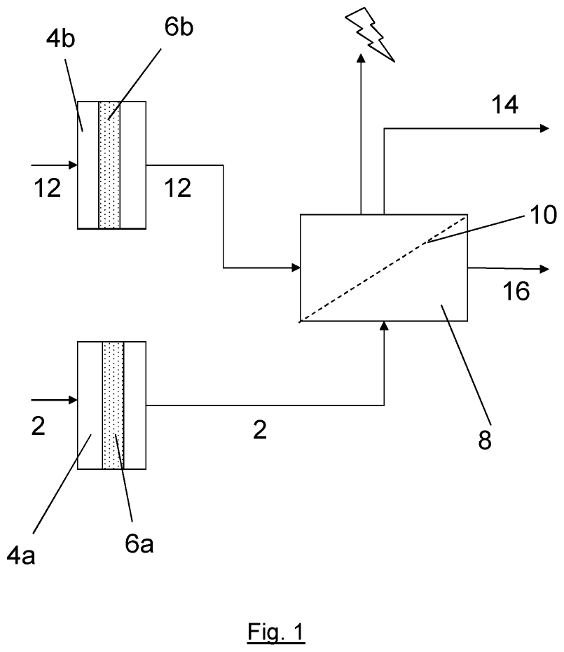

FIG. 1 shows a schematic illustration of an example process in accordance with the invention at a first time. In FIG. 1 a feed stream 2 is passed through a first ion exchange unit 4a comprising an ion exchange resin 6a. In some embodiments, the ion exchange resin 6a is a cationic exchange resin capable of binding divalent cations present in the feed stream 2 and comprises moveable ions such as sodium. Ions with multivalent charge such as Ca′ and Mg′ will have a high affinity for the ion exchange resin 6a and will be exchanged for the sodium and thereby be absorbed into the resin. Thus, passage through the ion exchange unit 4a purifies the feed stream 2. A draw stream 12, which is a high salinity stream, for example a saturated saline stream, is passed through a second ion exchange unit 4b comprising an ion exchange resin 6b which is the same resin as ion exchange resin 6a but in a depleted state—i.e. the supply of moveable ions has been depleted and ions found in the feed stream 2 have been absorbed into the resin. In some embodiments, in this state, ion exchange resin 6b is a cationic exchange resin capable of binding monovalent cations. In some embodiments the draw stream 12 is a saline stream comprising high concentrations of dissolved Sodium Chloride (NaCl). Ca′ and Mg′ from the resin 6b migrate into the draw stream 12 as it passes over the ion exchange resin 6b and are replaced by sodium ions from the draw stream 12. Thus, draw stream 12 regenerates the ion exchange resin 6b.

After passage through the first ion exchange unit 4a the feed stream 2 is passed to an osmotic power unit 8 where the feed stream 2 flows on one side of a semi-permeable membrane 10 (indicated by a dashed line in FIG. 1) that permits the passage of water but not salts. After passage through the second ion exchange unit 4b the draw stream 12 is passed to the osmotic power unit 8 where the draw stream flows on the other side of the semi-permeable membrane 10 to the feed stream 2. Within the osmotic power unit 8 water flows from the feed stream 2 into the draw stream 12 via the semi-permeable membrane 10 thereby increasing the pressure of the draw stream due to the increased volume in a confined space. In the present embodiment this excess pressure is ultimately converted to electricity by conventional means not shown, but in other embodiments this excess pressure may be used to do mechanical or other work. Output from the osmotic power unit 8 are a diluted draw stream 14 (being the draw stream 12 diluted by water that has crossed the semi-permeable membrane 10 from the feed stream 2); a concentrated feed stream 16 (being the feed stream 2 minus the water that has crossed the semi-permeable membrane 10 to the draw stream 12); and electricity. It will be appreciated that the process of FIG. 1 will include other elements, for example pumps and/or pressure exchanges not shown here for the sake of clarity.

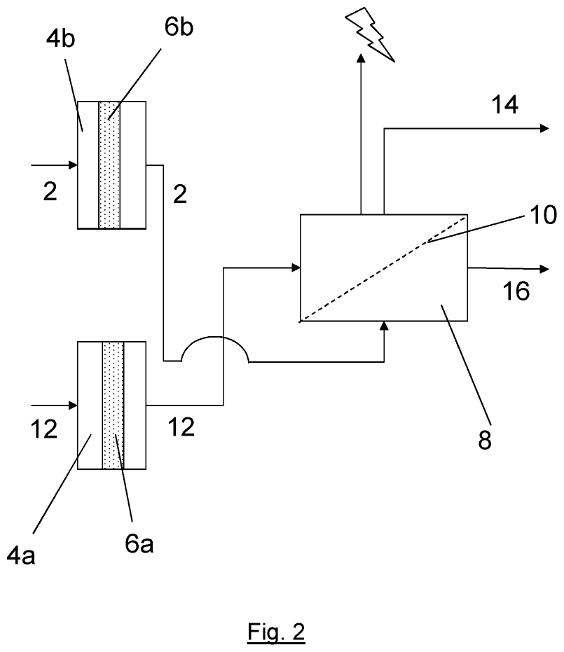

FIG. 2 shows a schematic illustration of the embodiment of FIG. 1 at a second time later than the first time. In FIG. 2, the feed stream 2 is passed through the second ion exchange unit 4b before going on to the osmotic power unit 8 as in FIG. 1. The draw stream 12 is passed through the first ion exchange unit 4a before going on to the osmotic power unit 8 as in FIG. 1. The outputs from the osmotic power unit 8 remain the same. Thus, in the arrangement of FIG. 2 the feed stream 2 is purified by passage through the second ion exchange unit 4b, the ion exchange resin 6b of that unit having previous been regenerated by the draw stream 12 in the process of FIG. 1. Meanwhile, the draw stream 12 regenerates the ion exchange resin 6a of the first ion exchange unit 4a that was previously depleted by the feed stream 2 in the process of FIG. 1.

While FIGS. 1 and 2 describe a system comprising an osmotic power unit 8 configured for Pressure Retarded Osmosis (PRO) it will be appreciated that the embodiments of the present invention are not limited to processes in which the osmotic unit generates power. Thus, the osmotic power unit 8 may be replaced with an osmotic unit configured for other osmotic processes, for example Forward Osmosis (FO). Depending on the nature of the osmotic process in question, the membrane 10 may be absent in some embodiments.

Thus, processes in accordance with the example embodiment of FIGS. 1 and 2 may use the draw stream of an osmotic process such as PRO or FO to regenerate the ion exchange resin that is used to treat the feed stream of the osmotic process. In this way, the cost of purification of the feed stream is reduced because the need for an external supply of salt for regeneration is reduced or removed. Additionally or alternatively, and without wishing to be bound by theory, the energy required to remove the divalent ions from the feed stream is contained within the osmotic or “entropic” potential between the feed and draw stream and thus no external energy inputs other than for pumping are required to pretreat the feed stream. Because the salt supply for ion exchange is essentially ‘free’ (it being required anyway for the osmotic process) many of the commercial restraints that limit the efficacy of the ion exchange process are removed in example embodiment of the invention. Thus, osmotic processes in accordance with the present example may having increased efficiency and/or result in improved treatment of the feed stream.

Additionally or alternatively, because the draw stream 12 used to regenerate the resin 6 is passed to the osmotic power unit 8 where it is diluted, processes in accordance with the present invention may reduce the amount of highly saline water that must be disposed of.

In some embodiments, the feed stream 2 is groundwater. In other embodiments the feed stream 2 is surface water, for example river water, wastewater, for example sewage, or industrial water such as condensate. In yet further embodiments the feed stream 2 is brackish water or seawater.

In some embodiments, the ion exchange resin 6a, 6b, 6c, 6d is an anionic exchange resin capable of binding divalent and higher valency ions present in the feed stream 2. Ions of higher valency such as sulfate ad phosphate will tend to have larger size compare to monovalent ions such as chloride and thus a lower diffusion coefficient. This means they will reach higher concentrations in the support layer of the semi-permeable membrane 10 (or the membranes of a RED unit, see below)—a phenomenon known as internal concentration polarization. Concentration is determined by the flux of feed water through the membrane, the membrane/ion rejection and the ion back diffusion rate. By exchanging ions with lower diffusion coefficient to ions with higher diffusion coefficients, a lower internal concentration polarization may be achieved.

In another embodiment the anionic exchange resin is capable of binding nitrate, allowing for selective removal of both nitrogen and phosphorous nutrients from the feed stream 2 and thereby lowering the concentration of these in concentrated feed stream 16.

In another embodiment, a mixture of cationic and anionic exchange resins are used. The different resins can be used in a mixed bed in the same column or in separate columns placed in series.

In some embodiments, antiscalants are added to the feed stream 2 at point(s) along the flow path between the ion exchange unit 4 and the osmotic power unit 8. Antiscalants can be used to avoid scaling of minerals not removed by the ion exchange process.

In some embodiments, the pH of the effluent feed stream 2 from the ion exchange unit is adjusted before entering the osmotic power unit 8.

In some embodiments other pretreatment processes are carried out on the feed stream 2 before it enters the osmotic power unit. These may include sand filtration, microfiltration, ultrafiltration, nanofiltration and/or reverse osmosis.

In some embodiments oxygen is removed from the feed stream 2 and/or the draw stream 12 upstream of the ion exchange unit 4. This is done to keep redox active species such as iron and manganese in the form of iron(II) and manganese(II), which can be bound by the ion exchange resin. Oxygen can be removed by adding an oxygen scavenger (not shown).

In some embodiments, pretreatment of the draw stream 12 is carried out before it enters the osmotic power unit, either before or after the ion exchange unit 4. This may include sand filtration, microfiltration, ultrafiltration, nanofiltration and reverse osmosis.

In some embodiments, the draw stream 12 is a saline stream, for example a saturated saline stream or a saline stream with a salt content of at least 10% wt.

The osmotic process can operate if there is an osmotic difference between the feed stream 2 and the draw stream 12 and the integration with ion exchange as pretreatment can be used for all such draw/feed combinations. The operation of the ion exchange unit 4 is however improved with increasing salinity of the draw solution 12 as it allows a more complete desorption of the bound ions during regeneration.

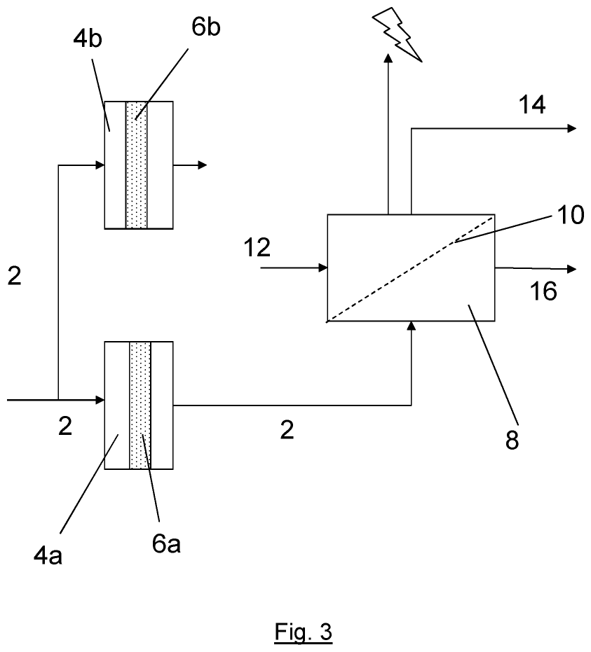

After a time it is necessary to switch from the process of FIG. 1 to the process of FIG. 2 (i.e. to take the first ion exchange unit 4a ‘offline’ for regeneration and to put the second ion exchange unit 4b ‘online’ for treatment of the feed stream). FIG. 3 shows a schematic view of the process while the second ion exchange unit 4b is being prepared to come ‘online’. To prepare the second ion exchange unit 4b for use in treating the feed stream 2, the supply of draw solution 12 to the ion exchange unit 4b is stopped and a portion of the feed stream 2 is passed to the ion exchange unit 4b to flush out the draw solution contained in the unit. In other embodiments another low salinity stream, not being the feed stream 2 may be used. At least one bed volume of fluid from the feed stream 2 is passed through the ion exchange unit 4b to displace the draw solution thereby producing a volume of displaced draw solution (hereafter the displaced draw solution) and (optionally) rinsing fluid, the rinsing fluid being the fluid from the feed stream 2 that has been used to displace the draw solution.

The rinsing fluid may be collected in a tank for future use, used to wash out a tank that has held the displaced draw solution to remove any remaining salinity and/or disposed of as appropriate.

In some embodiment the regeneration of the ‘offline’ ion exchange unit 4 is done continuously with the draw solution 12 running through the offline unit until the unit is brought online. In other embodiments the regeneration of the ‘offline’ ion exchange unit 4 with the draw solution 12 takes place for a specific period of time, after which the draw solution 12 bypasses the ion exchange unit 4, the column rinsed and placed in standby until it is required.

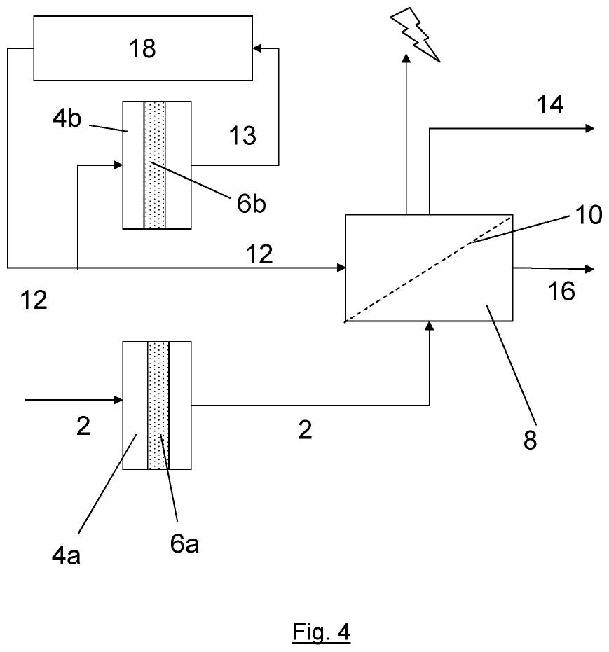

FIG. 4 shows a variation of the process of FIG. 1 in which the portion of the draw stream 12 used to regenerate the ion exchange resin 6b (which may be referred to as the regeneration stream 13) is discarded rather than being sent to the osmotic power unit 8. In FIG. 4 the regeneration stream 13 is pumped to a draw stream reservoir 18 from which the draw stream 12 is extracted. In other embodiments, the regeneration stream is discarded elsewhere. In some circumstances it may be desirable for the regeneration stream to bypass the osmotic power unit because some species like ammonium are poorly retained by the semi-permeable membrane 10 (or the membranes of a RED unit, see below), and could end up in the concentrated feed stream 16 if the regeneration stream is sent directly to the osmotic power unit 8.

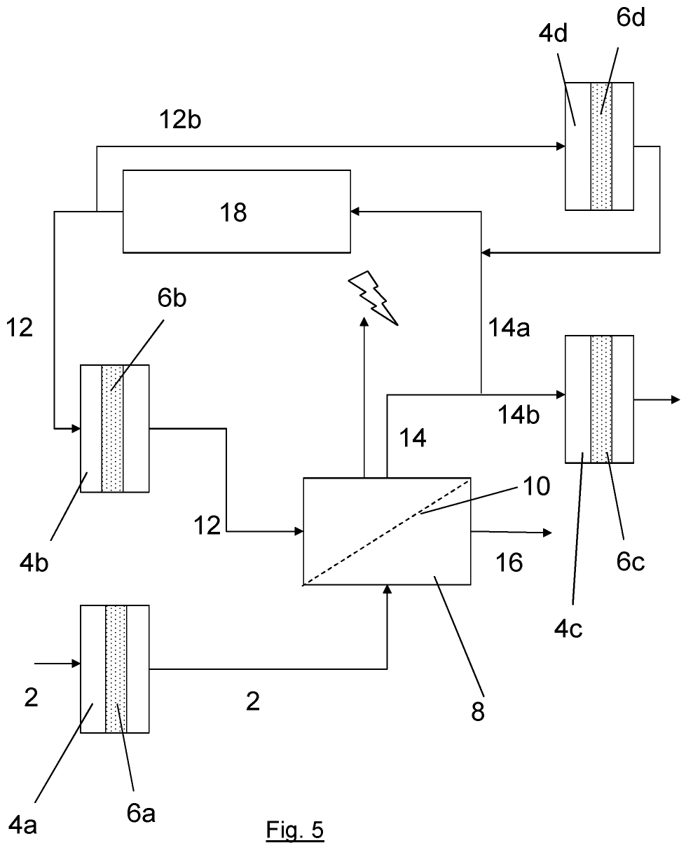

FIG. 5 shows a variation of the process of FIG. 1 in which a portion of the diluted draw stream 14 is purified prior following passage through the osmotic power unit 8. Only those aspects of FIG. 5 that differ with respect to FIG. 1 will be described here. In FIG. 5, a first portion of the diluted draw stream 14a is returned to a reservoir 18, for example the reservoir from which the draw stream 12 is extracted. A second portion of the diluted draw stream 14b is passed to a third ion exchange unit 4c comprising an ion exchange resin 6c before being disposed of in a river, lake or other body of water (not shown). In some embodiments the second portion of the diluted draw stream 14b is disposed of by discharge into the reservoir from which the feed stream 2 is extracted (not shown). In some embodiments, the ion exchange resin 6c is a cationic exchange resin capable of absorbing ammonium ions (NH₄⁺) in exchange for sodium. Thus, passage of the second portion of diluted draw stream 14b through the ion exchange unit 4c purifies the diluted draw stream 14b. A second portion of the draw stream 12b is passed to a fourth ion exchange unit 4d comprising an ion exchange resin 6d. The ion exchange resin 6d is the ion exchange resin 6c in a depleted state. As the draw stream 12b passes over the ion exchange resin 6d, ammonium ions desorb back into the draw stream 12b in exchange for sodium thereby regenerating the ion exchange resin 6d. The draw stream 12b comprising the ammonium ions is then returned to the reservoir 18. When the ion exchange resin 6c of the third ion exchange unit 4c is depleted, the flow of the second portion of the draw stream 12b and the second portion of the dilute draw stream 14b can be switched, so that the dilute draw stream 14b is purified by passage through the fourth ion exchange unit 4d while the third ion exchange unit 4c is regenerated by the second portion of the draw stream 12b.

The separation factor between the diluted and undiluted draw solution depends on the salinities of these, but removal efficiency from the dilute draw solution may be improved by increasing dilution, as this increases the difference in salinity between the two solutions.

The process of FIG. 5 may find application in circumstances where it is desirable to conserve the total volume of fluid in the reservoir 18. To achieve that a portion of the diluted draw stream 14b, for example being equal to the permeate flow across the semi-permeable membrane 10 (dependent on density and/or whether it has been mixed with any other stream of the process) must be safely disposed of, for example into the body of water from which the feed stream 2 is obtained, or into another body of water such as a river or lake. The process of FIG. 5 may be used to reduce levels of specific contaminants, for example ammonium which may be present in reduced brines, which may be harmful to the recipient of the diluted draw stream 14b. Use of an ion exchange unit which is regenerated using the draw stream for the osmotic power unit may reduce the cost of such a process (for example by removing the need for an external salt supply) and/or increase the efficiency of such a process (as the osmotic gradient drives the purification process).

In another embodiment, the diluted draw stream 14 is mixed with the concentrated feed stream, displaced draw solution and/or rinsing fluid and/or additional low salinity solution such as, but not exclusively, feed stream 2, to bring down salinity before entering the third or fourth ion exchange unit 4c, 4d.

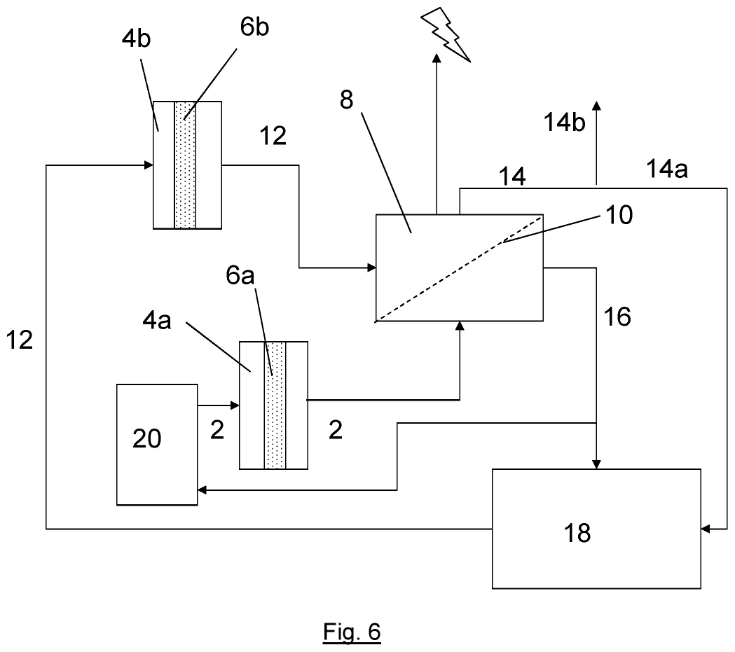

FIG. 6 shows a variation of the process of FIG. 1 in which the draw solution 12 is extracted from a reservoir 18. The concentrated feed stream 16 is returned to that reservoir 18 after passage through the osmotic power unit and/or to the reservoir 20 from which the feed stream 2 is extracted. A first portion of the dilute draw solution 14a is also returned to the reservoir 18. A second portion of the dilute draw solution 14b is returned to a river, lake or other body of water, or, optionally, the reservoir 20 from which the feed stream 2 is extracted. In some embodiments the second portion of the dilute draw solution 14b is treated as described above in connection with FIG. 6.

In some embodiments, the reservoir 20 from which the feed stream 2 is extracted may a river, lake or other body of water. In some embodiments the reservoir 18 is an underground salt formation or a geothermal reservoir. Such reservoirs may provide highly saline streams that increase the efficacy of the process described herein and/or which reduce the risk of fouling. In the case that the concentrated feed stream 16 and/or a portion of the dilute draw stream 14 is returned to the reservoir 18 this can be used as the unsaturated stream in a solution mining process in which salt in the salt formation is dissolved into the unsaturated stream to produce the draw stream 12. Such a process may be particularly cost and/or energy efficient. Additionally or alternatively, using the concentrated feed stream 16 and/or dilute draw stream 14 in the production of the feed stream 2 may reduce the amount of fresh water required for the process.

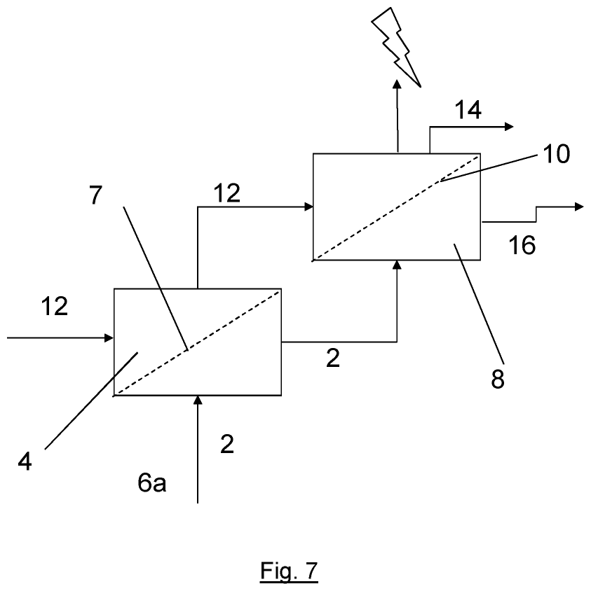

FIG. 7 shows an example process in accordance with embodiments of the invention. In FIG. 7 there is shown a single ion exchange unit 4 and an osmotic power unit 8. The ion exchange unit 4 comprises an ion exchange membrane 7 (indicated by a dashed line in FIG. 7). A draw stream 12 flows on one side of the ion exchange membrane 7 while a feed stream 2, being of lower salinity that the draw stream 12, flows on the other side of the membrane 7. The Donnan effect leads to an exchange of divalent ions in the feed stream 2 with monovalent ions in the draw stream 12. The monovalent ions in the draw stream 12 will diffuse along the concentration gradient into the feed solution 2, but since only ions of the same charge can pass the membrane and in order to maintain charge neutrality, divalent ions must diffuse from the feed stream 2 into the draw stream 12. After passing through the ion exchange unit 4 the draw stream 12 and the feed stream 2 are passed to an osmotic power unit 8 where they flow on either side of a semi-permeable membrane 10 that permits the passage of water but not salts. As described above, water passes across the membrane from the feed stream 2 to the draw stream 12 producing a diluted draw stream 14, a concentrated feed stream 16 and electricity. Thus, FIG. 7 shows a process with an osmotic power unit configured to generate electricity through PRO. In other embodiments, the osmotic unit may be configured to carry out other osmotic processes, for example FO or RED, and including osmotic processes in which electricity or power are not generated. Depending on the nature of the osmotic process, membrane 10 may be absent in some embodiments.

In one embodiment the ion exchange membrane 7 is a cationic exchange membrane. If the draw solution 12 is primarily sodium chloride and the feed stream 2 contains calcium ions, then two sodium ions will be transferred to the feed for every calcium ion removed, thereby treating the feed stream 2. In other embodiments, the ion exchange membrane is an anionic membrane. In the same or yet further embodiments, a series of cationic and anionic membranes are used to pretreat the feed stream 2.

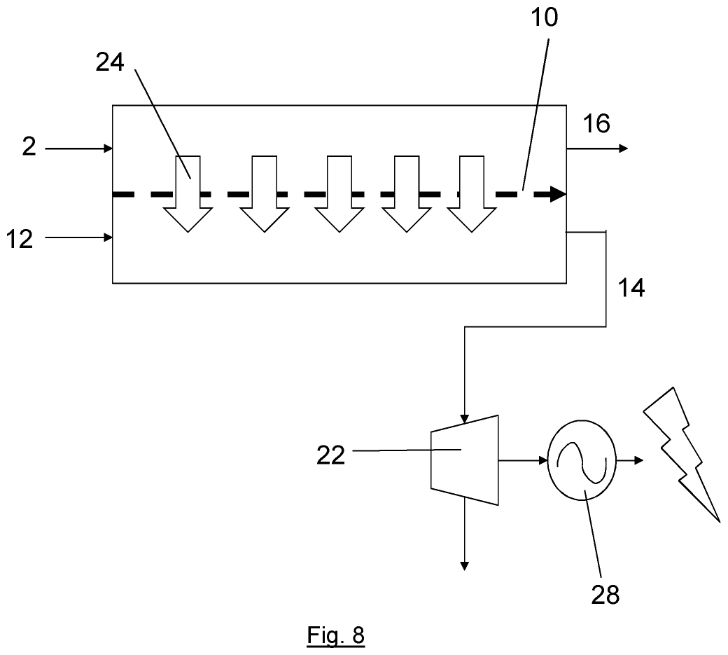

FIG. 8 shows the more details of an osmotic power unit 8, for example the osmotic power unit of FIGS. 1 to 7. A draw stream 12 is passed to the osmotic power unit 8 which contains a semi-permeable membrane 10 which permits passage of water but not of salts, and flows at one side of membrane 10. A feed stream 2 which is of lower salinity that draw stream 12 enters osmotic power unit 8 and flows at the other side of the membrane 8. Arrows 24 show the direction of water transport by osmosis across membrane 8. A dilute draw stream 14 consisting of original draw stream 12 and the water that has come across membrane 10 leaves the osmotic power unit 8 via a turbine 22 which drives a generator 28 thus producing electricity. In embodiments where the osmotic unit is not an osmotic power unit, turbine 22 and generator 28 may be absent.

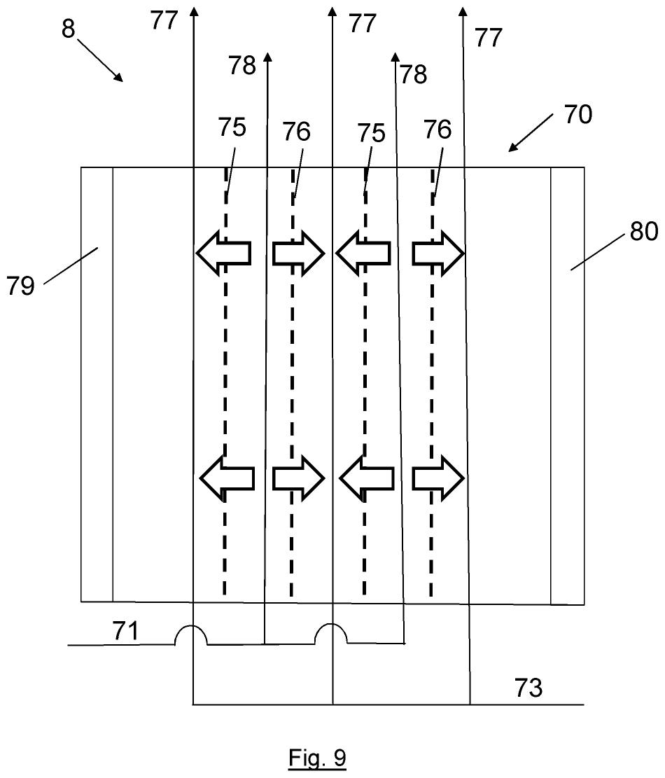

In some embodiments, the osmotic power unit 8 is a Reverse Electrodialysis (RED) unit comprising a plurality of cation exchange membranes and anion exchange membranes. FIG. 9 shows more details of an osmotic power unit that generates electricity using RED. The osmotic power unit 8 comprises a stack 70 of cation exchange membranes 75 alternating with an anion exchange membranes 76. The stack 70 is located between a cathode 79 (on the left of FIG. 9) and an anode 80 (on the right of FIG. 9). A saline stream 71 (which may for example be draw stream 12) flows between each cation exchange membrane 75 (on the left of stream 71 in FIG. 9) which permits the passage of cations (e.g. sodium) but not anions (e.g. chlorine) and an anion exchange membrane 76 (on the right of stream 71 in FIG. 9). An aqueous stream 73 (for example feed stream 2) which is of lower salinity than stream 71 flows on the other side of each cation exchange membrane 75 and the anion exchange membrane 76. Thus, there is an alternating series of saline streams 71 and aqueous streams 73 flowing through the stack 70. For the sake of clarity only four membranes are shown in FIG. 9, but the stack may include many more membranes. Arrows show the direction of sodium transport across cation exchange membrane 75 and chloride transport across anion exchange membrane 76. This movement of cations and anions across the membranes generates an electric current. An output stream 77 (for example concentrated feed stream 16) derived from original input stream 73 and now containing a higher concentration of salt, leaves osmotic power unit 70. An output stream 78 consisting of original input stream 71 now containing a lower concentration of salt (for example dilute draw stream 14), leaves osmotic power unit 8.

Whilst the present invention has been described and illustrated with reference to particular embodiments, it will be appreciated by those of ordinary skill in the art that the invention lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An osmotic process, the process comprising:
passing a draw stream and a feed stream, the feed stream being an aqueous stream of lower salinity than said draw stream, through an osmotic unit in which water but not salts pass from the feed stream to the draw stream;
passing the feed stream through an ion exchange unit in which an ion exchange process is used to treat the feed stream before the feed stream passes through the osmotic unit and
using the draw stream in said ion exchange process before or after the draw stream passes through the osmotic unit.

2. A process according to claim 1, wherein the osmotic unit comprises a semi-permeable membrane which permits a passage of water but not a passage of salts, the draw stream being passed over one side of the semi-permeable membrane, the feed stream being passed over a second side of said membrane so water passes across the membrane from the feed stream to the draw stream.

3. A process according to claim 1, wherein the ion exchange unit comprises an ion exchange membrane and the process comprises passing the feed stream over one side of the ion exchange membrane, the draw stream being passed over a second side of said ion exchange membrane.

4. A process according to claim 1, wherein the ion exchange unit comprises a first portion of ion exchange resin and the process comprises passing the feed stream over said first portion of ion exchange resin at a first time and passing the draw stream over said first portion of ion exchange resin at a second, different, time.

5. A process according to claim 4, wherein for a first time period the feed stream is passed over the first portion of ion exchange resin and the draw stream is passed over a second, different portion of ion exchange resin; and for a second time period the feed stream is passed over the second portion of ion exchange resin and the draw stream is passed over the first portion of ion exchange resin.

6. A process according to claim 4, wherein the draw stream passes over the first or second portion of ion exchange resin and then passes through the osmotic unit.

7. A process according to claim 4, wherein the or each portion of ion exchange resin is switched from an online state in which the feed stream flows over the resin to an offline state in which the draw stream flows over the first portion of ion exchange resin while at least 20% to 50% of the first portion of ion exchange resin capacity remains.

8. A process according to claim 1, wherein a salt content of the draw stream is at least 10% to 25% wt.

9. A process according to claim 1, further comprising extracting the draw stream from an underground formation, for example a geothermal formation and/or salt formation.

10. A process according to claim 9, wherein outputs from the osmotic unit comprise a diluted draw stream and a concentrated feed stream and the diluted draw stream and/or the concentrated feed stream are returned to the underground formation, and optionally, wherein the underground formation is a salt formation and the diluted draw stream is returned to the salt formation in order to dissolve salt therein and thereby produce the draw stream.

11. (canceled)

12. A process according to claim 1, wherein the feed stream is ground water, sea water, fresh or brackish water obtained from a river or a lake, waste water obtained from an industrial source, for example condensate, and/or municipal source, for example sewage.

13. A process according to claim 1, further comprising passing a dilute draw stream from the osmotic unit through an ion exchange unit comprising a portion of ion exchange resin to treat the dilute draw stream; and then regenerating said portion of ion exchange resin using the draw stream.

14. A process according to claim 1, wherein the first portion of ion exchange resin is a cationic ion exchange resin, for example configured to bind one or more of: magnesium, calcium, ammonium, aluminum, barium, manganese, strontium and iron ions in the feed stream in exchange for sodium ions; or anionic exchange resin, for example configured to bind one or more of: nitrate, carbonate and sulfate ad phosphate ions present in the feed stream in exchange for chloride ions.

15. A process according to claim 1, wherein the salinity of the draw stream remains substantially constant as it passes from one of the ion exchange unit and the osmotic unit to an other of the ion exchange unit and the osmotic unit.

16. A power generation process comprising a process according to claim 1, wherein the osmotic unit is an osmotic power unit and further comprising converting latent osmotic energy present in the draw stream into power by passing at least part of said draw stream through the osmotic power unit in which said draw stream is passed over one side of a semi-permeable membrane which permits a passage of water but not the passage of salts, a feed stream, being an aqueous stream of lower salinity than said draw stream, being passed over a second side of said membrane so water passes across the membrane from the feed stream to the draw stream.

17. An electricity generation process, the process comprising:
passing at least part of a draw stream, the draw stream being a saline stream having a salt content of at least 10% wt, through a reverse electrodialysis unit in which said draw stream is passed over one side of a cation-exchange membrane which permits a passage of cations but not the passage of anions and over one side of an anion-exchange membrane which permits the passage of anions but not cations, and a feed stream, being an aqueous stream of lower salinity than said draw stream, is passed over a second side of said cation-exchange membrane and the other side of said anion-exchange membrane to generate electricity;
passing the feed stream through an ion exchange unit in which an ion exchange process is used to treat the feed stream before the feed stream passes through the reverse electrodialysis unit, and
using the draw stream in said ion exchange process before or after the draw stream passes through an osmotic power unit.

18. A process according to claim 17, wherein (i) the ion exchange unit comprises a first portion of ion exchange resin and the process comprises passing the feed stream over said first portion of ion exchange resin at a first time and passing the draw stream over said first portion of ion exchange resin at a second, different, time; and/or (ii) the ion exchange unit comprises an ion exchange membrane and the process comprises passing the feed stream over one side of the ion exchange membrane, the draw stream being passed over the other side of said ion exchange membrane.

19. A system for carrying out the process of claim 1, the system comprising a first portion of ion exchange resin and a second portion of ion exchange resin; and an osmotic unit arranged to carry out an osmotic process using a difference in salinity between a draw stream and a feed stream, the system being switchable between a first configuration and a second configuration, wherein
in the first configuration the feed stream passes over the first portion of ion exchange resin and the draw stream passes over the second portion of ion exchange resin; and
in the second configuration the feed stream passes over the second portion of ion exchange resin and the draw stream passes over the first portion of ion exchange resin.

20. A system according to claim 19, wherein the osmotic process is Pressure Retarded Osmosis, Forward Osmosis and/or Reverse Electrodialysis.

21. A system according to claim 19, comprising one or more valves that control a flow of the draw stream and/or the feed stream through the system such that operating said valves switches the system between the first and second configurations.

22. A system according to claim 19, comprising an injection well configured to inject a dilute draw stream output from the osmotic unit into a salt formation, and an extraction well configured to extract the draw stream from the salt formation.

23. (canceled)
